(19) United States
(12) Patent Application Publication
(10) Pub. No.: US 2010/0015986 A1
(43) Pub. Date: Jan. 21, 2010

(54) Radio Base Station, Radio Communication Terminal, Radio Communication System and Radio Communication Method

(75) Inventor: Kenji Kono, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/095,308

(22) PCT Filed: Nov. 22, 2006
(86) PCT No.: PCT/JP2006/323333

§ 371 Date: Sep. 30, 2009

(30) Foreign Application Priority Data
Nov. 28, 2005 (JP) 2005-342176
Nov. 28, 2005 (JP) 2005-342180
Dec. 20, 2005 (JP) 2005-366233

(51) Int. Cl. H04W 72/04

(52) U.S. Cl. 455/450

(57) ABSTRACT

A radio base station 100 according to the present invention notifies a radio base station 200 of a communication level of an application in execution by a radio communication a terminal 300, when handoff of the radio communication terminal 300 from the radio base station 100 to the radio base station 200 is performed. To the radio communication terminal 300, the radio base station 200 transmits information for controlling a reverse link communication rate from the radio communication terminal 300 on the basis of the communication level. The radio communication terminal 300 controls the reverse link communication rate on the basis of the information notified by the radio base station 200.

### TECHNICAL FIELD

The present invention relates to a radio base station, a radio communication terminal and a radio communication system, which are used in a radio communication system including a mixture of radio base stations having different communication capabilities.

In addition, the present invention relates to a radio communication terminal and a radio cornnunication method that are provided for controlling a communication rate of reverse link data by increasing or decreasing an upper limit value in a stepwise manner on the basis of probabilities.

### BACKGROUND ART

In a CDMA2000 1xEV-DO (hereinafter, referred to as 1xEV-DO) system, a data communication rate of a radio communication terminal such as a mobile telephone is controlled on the basis of: information, “RAbit (Reverse Activity Bit)” indicating an instruction to increase or decrease an upper limit value of the communication rate; and a threshold value determined when a session is established, the information being transmitted from a base station at each predetermined timing.

FIG. 1 is a data communication rate change test table used in a 1xEV-DO system (for example, “cdma2000 High Rate Packet Data Air Interface 3GPP2 C.S0024 Version 4.0 section 8.5.6.1.5.2 Rate Control,” 3GPP2, October 2002). As shown in FIG. 1, in 1xEV-DO, an upper limit value of a data communication rate is set at five levels: 9.6 kbps; 19.2 kbps; 38.4 kbps; 76.8 kbps; and 153.6 kbps. When a radio communication terminal starts communications with a radio base station, the communications start at the lowest communication rate (9.6 kbps). Thereafter, the radio communication terminal receives a RAbit transmitted from the base station, and adjusts the communication rate on the basis of the received RAbit.

The RAbit is a bit value that changes depending on the amount of congestion of the base station currently connected to the radio communication terminal and of handoff target peripheral base stations. The congestion of a base station refers to a situation where a large number of radio communication terminals are connected to the base station in a concentrated manner, or congestion refers to a situation where a crowded situation occurs in a communication line connected to the base station, or the like.

When communications in a base station are not congested, that is, when it is possible to increase the communication rate, the RAbit is set to “0.” On the other hand, when communications in a base station are determined to be congested, that is, when it is not preferable to increase the communication rate, the RAbit is set to “1.”

FIG. 2 is a flow chart showing processing for changing a data communication rate by a radio communication terminal supporting 1xEV-DO.

The radio communication terminal supporting 1xEV-DO (hereinafter, referred to as the radio communication terminal) first starts communications at the lowest communication rate (9.6 kbps) (step 9001).

Upon receipt of a RAbit, the radio communication terminal determines whether or not the received RAbit is “1” (step 9002). In a case where the radio communication terminal determines that the RAbit is “0” (YES in step 9002), the radio communication terminal operates to increase the upper limit value of the current communication rate by one level. In this case, the communication rate is configured to increase not in an absolute manner, but in a probabilistic manner.

First, the radio communication terminal generates a random number x (0<x<1), (step 9003). Next, the radio communication terminal determines whether or not the generated random number x is smaller than a threshold value α for changing the communication rate (step 9004). Here, as shown in FIG. 1, a threshold value α varies depending on the current communication rate. For example, when an upper limit value is to be increased by one level from 9.6 kbps to 19.2 kbps, the threshold value α becomes a value obtained by dividing “48” by “255,” that is, “48/255.” In this example, the radio communication terminal determines whether the random number x is greater or smaller than “48/255.”

In a case where the radio communication terminal determines that the random number x is equal to or greater than the threshold value α (YES in step 9004), the radio communication terminal increases the upper limit value of the current communication rate by one level (step 9005). For example, when the upper limit value of the current communication rate is 9.6 kbps, the radio communication terminal increases the upper limit value to 19.2 kbps, which is one level higher than the current level. On the other hand, in a case where the radio communication terminal determines that the random number x is smaller than the threshold value α (NO in step 9004) , the radio communication terminal maintains the upper limit value of the current communication rate (step 9006). For example, when the upper limit value of the current communication rate is 9.6 kbps, the radio communication terminal maintains the upper limit value at 9.6 kbps.

On the other hand, in a case where the radio communication terminal determines that the RAbit is “1,” the radio communication terminal operates to decrease the upper limit value of the current communication rate by one level. Specifically, the radio communication terminal generates a random number x (0<x<1) (step 9007) and compares the random number x with a threshold value α′ (step 9008). In a case where the radio communication terminal determines that the random a number x is smaller than the threshold value α′ (YES in step 9008), the radio communication terminal decreases the upper limit value of the current communication rate by one level (step 9009). For example, when the upper limit value of the current communication rate is 19.2 kbps, the radio communication terminal decreases the upper limit value to 9.6 kbps, which is one level lower than the current level. On the other hand, in a case where the radio communication terminal determines that the random number x is equal to or greater than the threshold value α′ (NO in step 9008), the radio communication terminal maintains the upper limit value of the current communication rate (step 9006). For example, when the upper limit value of the current communication rate is 19.2 kbps, the radio communication terminal maintains the upper limit value at 19.2 kbps.

As described above, in a 1xEX-DO system, the radio communication terminal controls the upper limit value of a communication rate at least in reverse link communications so as to increase or decrease the upper limit value by one level, or to maintain, on the basis of a RAbit transmitted from a base station at each predetermined timing and of a threshold value determined when a session between the radio communication terminal and the base station is established.

Incidentally, development of CDMA2000 1xEV-DO rev.A (hereinafter, referred to as 1xEV-DO rev.A), which expands the communication scheme of aforementioned 1xEV-DO (hereinafter, referred to as 1xEV-DO rev.0) is currently in progress. As a function to be newly added in 1xEV-DO rev.A, there is a QoS (Quality of Service) control. According to the QoS control, a priority is given to packets of each application to be executed on the radio communication terminal, and packets with high priority are transferred first. Specifically, without performing the aforementioned control of a communication rate in a stepwise manner on the basis of probabilities, a communication rate required for an application to be executed on the radio communication terminal can be secured from the beginning of the communications. In addition, during the communications, the communication rate can be relatively freely changed in accordance with the communication rate required for the application.

### DISCLOSURE OF THE INVENTION

In a case where handoff of a radio communication terminal supporting 1xEV-DO rev.A to a base station supporting 1xEV-DO rev-0 is performed while the radio communication terminal is executing an application that requires some degree of a communication rate between itself and a base station supporting 1xEV-DO rev.A, or in a case where a radio communication terminal supporting 1xEV-DO rev.A executes an application that requires some degree of a communication rate between itself and a base station supporting 1xEV-DO rev.0, the radio communication terminal has to start communications initially at 9.6 kbps, and cannot obtain the required communication rate without performing the aforementioned communication rate increase test based on probabilities. In the aforementioned prior art, controls on the basis of the same probabilities are performed in increasing or decreasing of a communication rate for communications that require some degree of a communication rate not allowing delay, and for communications that can be executed at a low communication rate, however, since only one threshold value α is provided to each communication rate (upper limit value).

For example, a description of a case of an IP phone will be given. In an IP phone, voice data is formed into an IP packet (VoIP), and the IP packet is delivered to another party via a normal IP network. Since a dedicated voice network (line switching network) is not used, delay occurs easily in a network path. In the specification, however, delay not less than a certain period of time is not allowed since the application is voice communications. In other words, although a communication rate of 70 to 80 kbps is required in general, communications always start at 9.6 kbps in 1xEV-DO rev-0, and the aforementioned communication rate increase test needs to be performed at least three times until the required communication rate is achieved. Actually, the aforementioned communication rate increase test is controlled by the probabilities, so that the probability for allowing an increase in the communication rate becomes lower as the communication rate becomes higher. It is thus necessary to pass the test a considerable number of times for obtaining the required communication rate. “Delay” of an IP packet occurs therefore.

Moreover, an IP phone uses “voice activity detection,” which aims to achieve effective usage of bandwidth by not transmitting data from a party in silence, that is, by not transmitting data during a period of silence. For example, while a user is listening to another party, the radio communication terminal does not transmit voice data (IP packet), and starts transmission of voice data when the user starts talking. Specifically, in a case where the radio communication terminal executes an IP phone call in accordance with 1xEV-DO rev.0, the reverse link communication rate when the user starts talking during the call is always 9.6 kbps. Furthermore, due to the aforementioned communication rate increase test, it requires some time until the required communication rate is fully achieved. In other words, delay always occurs when the user starts talking.

In this respect, an object of the present invention is to provide a radio base station, a radio communication terminal and a radio communication system that are capable of performing, without reducing a quality of service for an application in execution, handoff from a radio base station capable of allocating a desired reverse link communication rate to a radio base station that controls a communication rate by changing an upper limit value of the communication rate in a stepwise manner.

Furthermore, an object of the present invention is to provide a radio communication terminal and a radio communication method that are capable of, by preparing a plurality of values for a threshold value α for controlling an increase or decrease in a communication rate, increasing the communication rate with a high probability for communications that require a high communication rate, and capable of preventing a reduction in a quality of service for a communication application.

Furthermore, an object of the present invention is to provide a radio communication terminal and a radio communication method that are capable of increasing a reverse link communication rate with a high probability for communications with no delay allowed and requiring a high communication rate, and capable of preventing a reduction in a quality of service for a communication application.

In order to solve the aforementioned problem, a first aspect of the present invention is summarized as a radio communication terminal comprising: a storage unit configured to store a plurality of threshold values for changing an upper limit value of a communication rate, for each of the upper limit value set in a stepwise manner; and a controller configured to select, in accordance with an application to be executed, threshold values corresponding to a reverse link communication rate required for the application from the storage unit, and to control a reverse link communication rate of the application on the basis of the selected threshold values.

A second aspect of the present invention is summarized as a radio communication terminal comprising: a setting unit configured to set, for a radio base station, a plurality of communication settings defining an optimum value of each application as a threshold value for changing an upper limit value of a communication rater for each of the upper limit value set in a stepwise manner; and a controller configured to control a reverse link communication rate to the radio base station by use of the communication settings in accordance with an application to be started.

A third aspect of the present invention is summarized as the radio communication terminal according to the first aspect, the controller notifies a radio base station of the threshold values selected in accordance with a reverse link communication rate required for the application when executing the application.

A fourth aspect of the present invention is summarized as a radio communication method comprising: providing a plurality of threshold values for changing an upper limit value of a communication rate, for each of the upper limit value set in a stepwise manner; selecting, in accordance with an application to be executed by a radio communication terminal, the threshold values corresponding to a reverse link communication rate required for the application; and controlling a reverse link communication rate of the application on the basis of the selected threshold values.

A fifth aspect of the present invention is summarized as a radio communication method comprising: setting, for a radio base station, a plurality of communication settings defining an optimum value of each application as a threshold value for changing an upper limit value of a communication rate, for each of the upper limit value set in a stepwise manner; and controlling a reverse link communication rate to the radio base station by use of the communication settings in accordance with an application to be started.

A sixth aspect of the present invention is summarized as a radio communication terminal comprising: a storage unit configured to store a threshold value for changing an upper limit value of a communication rate, for each of the upper limit value set in a stepwise manner, while associating the threshold value with an application; and a controller configured to select the threshold value associated with the application in accordance with the application to be executed, and to control a reverse link communication rate of the application on the basis of the selected threshold value.

A seventh aspect of the present invention is summarized as the radio communication terminal according to the sixth aspect, further comprising: a receiver configured to receive a threshold value set in a radio base station for changing an upper limit value of a communication rate for each of the upper limit value, from the radio base station; and a notification unit configured to notify the radio base station that the threshold value received by the receiver is used for controlling a reverse link communication rate by the controller.

An eighth aspect of the present invention is summarized as a radio communication method comprising: storing a threshold value for changing an upper limit value of a communication rate, for each of the upper limit value set in a stepwise manner, while associating the threshold value with an application; receiving a threshold value set in a radio base station for changing an upper limit value of the communication rate for each of the upper limit value set in a stepwise manner, from the radio base station; notifying the radio base station that the received threshold value is used for controlling a reverse link communication rate, while selecting, in accordance with an application to be executed, the threshold value stored in association with the application; and controlling a reverse link communication rate of the application on the basis of the selected threshold value.

A ninth aspect of the present invention is summarized as a radio base station comprising: a storage unit configured to store a plurality of threshold values for changing an upper limit value of a communication rate, for each of the upper limit value set in a stepwise manner; a receiver configured to receive, from a different radio base station, information indicating a reverse link communication rate required for an application executed by the radio communication terminal that performs radio communication with the different radio base station; and a notification unit configured to obtain, from the storage unit, the threshold values corresponding to information which is received by the receiver and indicates a reverse link communication rate required for the application, and to notify the radio communication terminal of the selected threshold values when handoff of the radio communication terminal is performed from the different radio base station to the radio base station.

A tenth aspect of the present invention is summarized as a radio base station comprising: a receiver configured to receive, from the radio communication terminal, information indicating a reverse link communication rate required for an application executed by the radio communication terminal; and a notification unit configured to notify a different radio base station of information which is received by the receiver and indicates a reverse link communication rate required for an application executed by the radio communication terminal when handoff of the radio communication terminal is performed from the radio base station to a different radio base station.

An eleventh aspect of the present invention is summarized as a radio communication terminal comprising: a transmitter configured to transmit, to a radio base station, information indicating a reverse link communication rate required for an application to be executed; a receiver configured to receive a threshold value from a radio base station in communication when handoff is performed from the radio base station in the communication to a different radio base station, the threshold value being determined for each of an upper limit value of a communication rate and being used for changing the upper limit value set in a stepwise manner; and a controller configured to control a reverse link communication rate of the application on the basis of the threshold value received by the receiver.

A twelfth aspect of the present invention is summarized as a radio communication system comprising: a first radio base station capable of allocating a desired reverse link communication rate in accordance with an application; a second radio base station configured to control a reverse link communication rate of the application by changing an upper limit value of the reverse link communication rate in a stepwise manner; and a radio communication terminal capable of communicating with the first radio base station and the second radio base station, wherein the first radio base station includes: a receiver configured to receive information indicating a reverse link communication rate required for the application when the radio communication terminal executes the application; and a notification unit configured to notify the second radio base station of the information which is received by the receiver and indicates a reverse link communication rate required by the application when handoff of the radio communication terminal from the first radio base station to the second radio base station is performed, the second radio base station includes: a storage unit configured to store a plurality of threshold values for changing an upper limit value of a communication rate, for each of the upper limit value set in a stepwise manner; a receiver configured to receive information indicating a reverse link communication rate required for the application executed by the radio communication terminal, from the first radio base station; and a notification unit configured to obtain, from the storage unit, the threshold values corresponding to information which is received by the receiver and indicates a reverse link communication rate required for the application, and to notify the radio communication terminal of the selected threshold values when handoff of the radio communication terminal is performed from the first radio base station to the second radio base station, the radio communication terminal includes: a transmitter configured to transmit information indicating a reverse link communication rate required for the application to be executed, to the first radio base station; a receiver configured to receive the threshold values determined based on the notified information indicating a reverse link communication rate, from the second radio base station, when handoff is performed from the first radio base station to the second radio base station; and a controller configured to control a reverse link communication rate of the application on the basis of the threshold values received by the receiver, after handoff from the first radio base station to the second radio base station is performed.

### BRIEF DESCRIPTION OF THE DRAWINGS

FIG. 1 is a diagram showing a conventional communication rate change test table.

FIG. 2 is a chart showing an operation flow of a communication rate change of a conventional radio communication terminal.

FIG. 3 is an entire schematic configuration diagram of a radio communication system according to a first embodiment of the present invention.

FIG. 4 is a functional block configuration diagram of a radio base station according to the first embodiment of the present invention.

FIG. 5 is a detailed functional block diagram of a system controller and a system memory of the radio base station according to the first embodiment of the present invention.

FIG. 6 is a detailed functional block diagram of a system controller and a system memory of the radio base station according to the first embodiment of the present invention.

FIG. 7 is a functional block diagram of a radio communication terminal according to the first embodiment of the present invention.

FIG. 8 is a detailed functional block diagram of a system controller and a system memory of the radio communication terminal according to the first embodiment of the present invention.

FIG. 9 is a chart showing an example of a communication rate change test table according to the first embodiment of the present invention.

FIG. 10 is a chart showing an operation flow of a radio base station according to the first embodiment of the present invention.

FIG. 11 is a chart showing an operation flow of a radio base station according to the first embodiment of the present invention.

FIG. 12 is a chart showing an operation flow of a radio communication terminal according to the first embodiment of the present invention.

FIG. 13 is a block configuration diagram of a radio communication terminal according to a second embodiment of the present invention.

FIG. 14 is a chart showing an example of a communication rate change test table according to the second embodiment of the present invention.

FIG. 15 is a chart showing an operation flow of the radio communication terminal according to the second embodiment of the present invention.

FIG. 16 is a block configuration diagram of a radio communication terminal and a radio base station according to a modification example of the second embodiment of the present invention.

FIG. 17 is a chart showing an example of a communication rate change test table and a communication setting according to the modification example of the second embodiment of the present invention.

FIG. 18 is a chart showing an operation flow of a radio communication terminal according to the modification example of the second embodiment of the present invention.

FIG. 19 is a schematic block configuration diagram of a radio communication terminal and a radio base station according to a third embodiment of the present invention.

FIG. 20 is a detailed functional block diagram of a system controller and a system memory according to the third embodiment of the present invention.

FIG. 21 is a detailed functional block diagram of a system controller and a system memory according to the third embodiment of the present invention.

FIG. 22 is a chart showing an example of a communication rate change test table according to the third embodiment of the present invention.

FIG. 23 is a chart showing an operation flow of the radio communication terminal according to the third embodiment of the present invention.

### BEST MODES FOR CARRYING OUT THE INVENTION

Hereinafter, embodiments of the present invention will be described in detail.

### First Embodiment

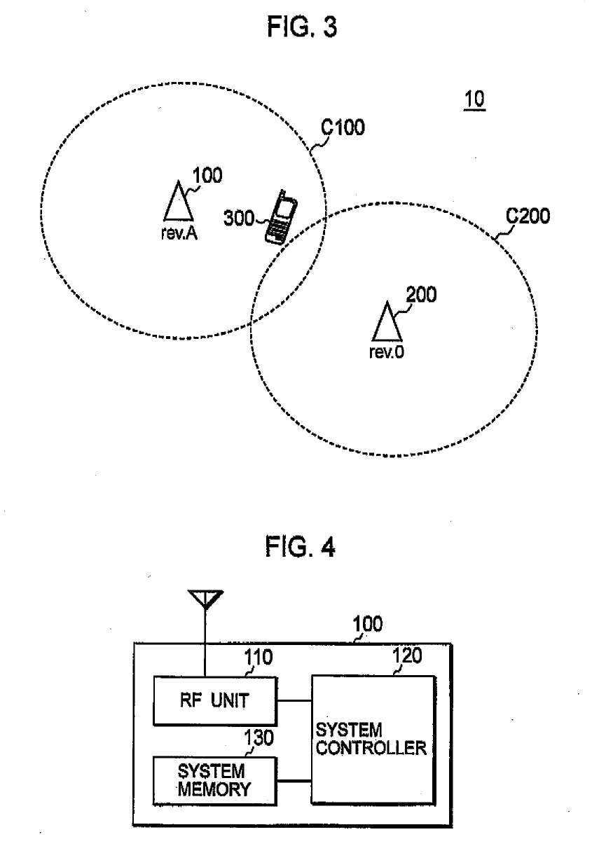

FIG. 3 is an entire schematic configuration diagram of a radio communication system according to a first embodiment of the present invention.

A radio communication system 10 shown in FIG. 3 is configured of a plurality of radio base stations (base stations 100 and 200) and a radio communication terminal 300. Note that the numbers of radio base stations and radio communication terminals constituting the radio communication terminal 10 are not limited to the numbers of those shown in FIG. 3.

The mobile communication system 10 is a radio communication system in accordance with a CDMA2000 scheme, and employs multiple schemes having different communication capabilities as the data communication schemes.

Specifically, 1xEV-DO rev.0 (hereinafter, referred to as rev.0) and 1xEV-DO rev.A (hereinafter, referred to as rev.A) are employed. Moreover, rev.0 achieves data rates of 153.6 kbps for reverse link and of approximately 2.4 Mbps for forward link, while rev.A (hereinafter, referred to as rev.A) achieves data rates of approximately 1.8 Mbps for reverse link and of approximately 3.1 Mbps for forward link.

The base station 100 is a base station supporting rev.0 and rev.A. The base station 200 is a base station supporting only rev. 0. The base stations 100 and 200 respectively form cells C100 and C200.

The radio communication terminal 300 is a terminal device supporting rev.0 and rev.A and executes communications with the radio base stations 100 and 200.

FIG. 4 is a block configuration diagram of the base station 100.

As shown in FIG. 4, the base station 100 is provided with an RF unit 110, a system controller 120 and a system memory 130.

The RF unit 110 transmits and receives a radio signal in accordance with CDMA to and from the radio communication terminal 300. Moreover, the RF unit 110 executes conversion of the radio signal into a baseband signal, and transmits and receives the baseband signal to and from the system controller 120.

The system controller 120 controls various types of functions included in the base station 100. A description of a more detailed functional block diagram of the system controller 120 related to the present embodiment will be given later.

The system memory 130 stores, therein, various types of information used in a control or the like performed in the base station 100. A description of more detailed functional blocks of the system memory 130 related to the present embodiment will be given later.

Note that the radio base station 200 supporting only rev.0 also includes the same functional block configuration as that of the radio base station 100 shown in FIG. 4.

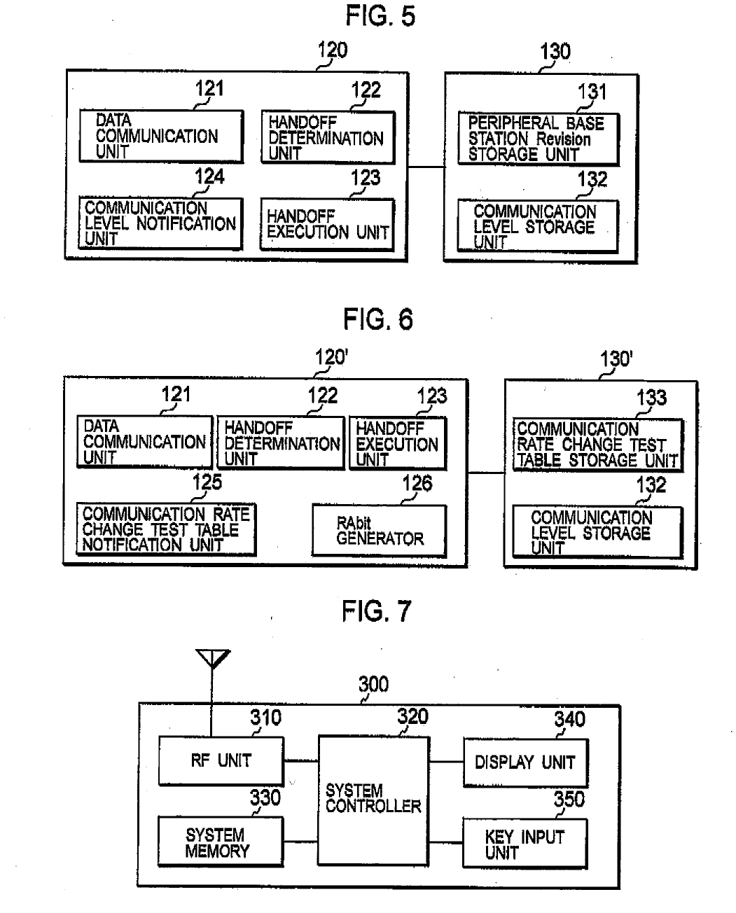

FIG. 5 is a detailed functional block configuration diagram of the system controller 120 and the system memory 130 of the radio base station 100.

As shown in FIG. 5, the system controller 120 of the radio base station 100 is provided with a data communication unit 121, a handoff determination unit 122, a handoff execution unit 123 and a communication level notification unit 124.

Furthermore, the system memory 130 is provided with a peripheral base station Revision storage unit 131 and a communication level storage unit 132.

The data communication unit 121 executes processing related to communications for image contents, music contents or the like or transmission and receipt of various types of control information.

FIG. 6 is a detailed functional block configuration diagram of a system controller 120′ and a system memory 130′ of the radio base station 200.

Note that a description will be omitted of a portion of the configuration of the system controller 120 that is the sate as that of the radio base station 100.

As shown in FIG. 6, the system controller 120′ of the radio base station 200 is provided with a data communication unit 121, a handoff determination unit 122, a handoff execution unit 123, a communication rate change test table notification unit 125 and a RAbit generator 126.

Moreover, the system memory 130′ is provided with a communication level storage unit 132, a communication rate change test table storage unit 133.

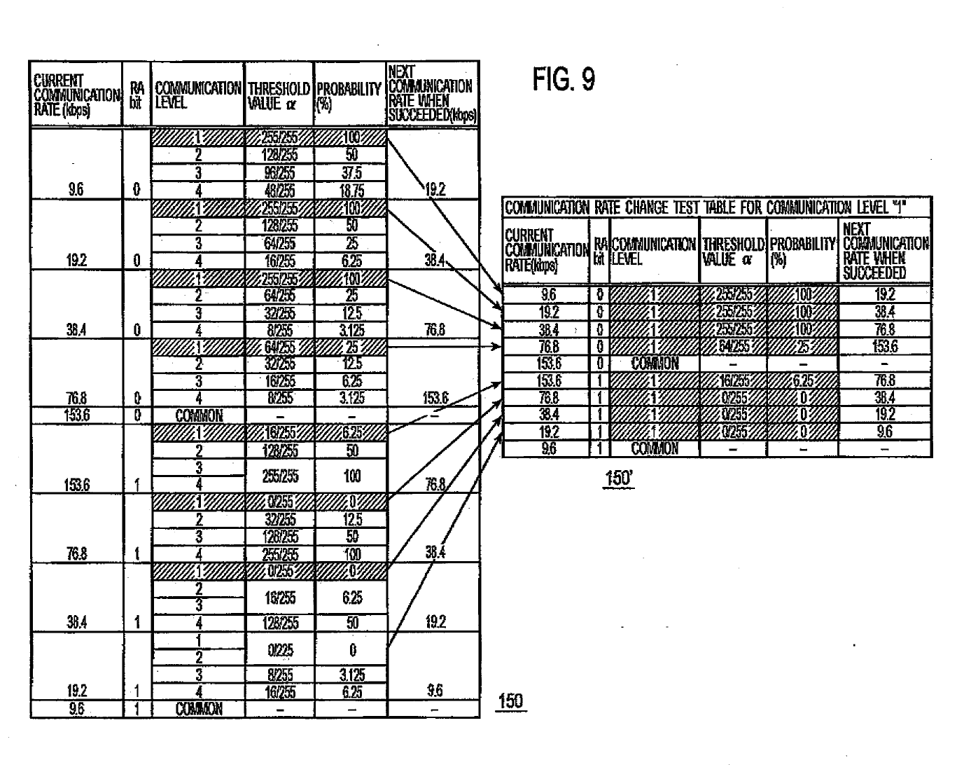

Here, a communication rate change test table 150 to be stored in the communication rate change test table storage unit 133 is shown in FIG. 9.

In FIG. 9, the communication rate change test table 150 is different from a conventional communication rate change test table in a point that a plurality of communication levels are provided in association with each of upper limit values respectively of reverse link communication rates, and a threshold value of the aforementioned probability test is provided for each of the communication levels.

Note that each of the communication levels is a value to be set on the basis of a communication rate required for an application in a communication level setting unit 124. In this embodiment, values at four phases from 1 to 4 are set for each of the upper limit values of the respective communication rates. The method of setting the communication levels is not limited to this, however. The values may be set at three phases for each of the upper limit values of the respective communication rates. Moreover, a different phase may be set for each of the upper limit values (four levels for 9.6 kbps, three levels for 19.2 kbps, and the like, for example). As a matter of course, the values of threshold values α are not limited to the values used in this embodiment.

According to the communication rate change test table 150, in a case where the communication level of an application is determined to be “1” while RAbit=0 (in other words, in a case where it is possible to increase the communication rate), the upper limit of the communication rate is always increased to 19.2 kbps, which is the next level, since the threshold value a corresponding to the communication level “1” at 9.6 kbps is “255/255”, for example, and thus α≧x (0<x<1) becomes always true (probability 100%). Likewise, since the threshold value α at 19.2 kbps and 38.4 kbps is “255/255” in a case where the communication level is “1,” the upper limit value is always increased to the next level.

Specifically, according to the communication rate change test table 150, for an application whose communication level is defined and set to be “1,” the upper limit value of the communication rate is surely increased to 76.8 kbps after a test is performed three times.

Moreover, in a case where RAbit=1 as well (in a case where it is not preferable to increase the communication rate) and where the communication level of the application is “1,” the communication rate can be maintained at 76.8 kbps since the threshold value α corresponding to the communication level “1” at 76.8 kbps is always “0/255,” and thus α<x (0<x<1) is always true (probability 100%).

FIG. 7 is a block configuration diagram of the radio communication terminal 300.

As shown in FIG. 7, the radio communication terminal 300 is provided with an RF unit 310, a system controller 320 and a system memory 330, a display unit 340 and a key input unit 350.

The RF unit 310, the system controller 320 and the system memory 330 provide the same functions as those of the RF unit 110, the system controller 120 and the system memory 130 of the base station 100, respectively.

The display unit 340 displays image contents or the like received via the RF unit 310 and the system controller 320, or displays operation contents (an input phone number, address or the like).

The key input unit 350 is configured of a ten key, function keys, or the like and is an interface used for inputting operation contents by the user.

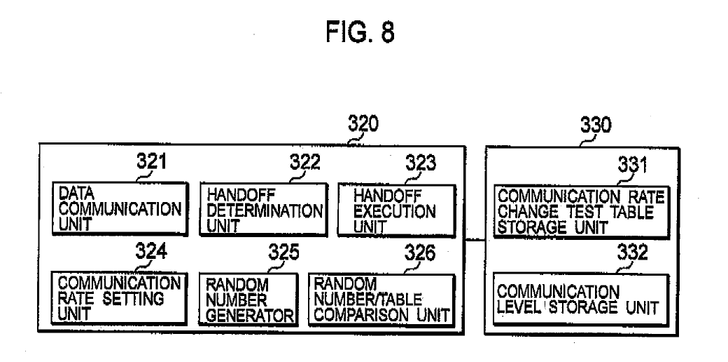

FIG. 8 is a detailed functional block configuration diagram of the system controller 320 and the system memory 330.

As shown in FIG. 8, the system controller 320 is provided with a data communication unit 321, a handoff determination unit 322, a handoff execution unit 323, a communication rate setting unit 324, a random number generator 325 and a random number/table comparison unit 326.

In addition, the system memory 330 is provided with a communication rate change test table storage unit 331 and a communication level storage unit 332.

The data communication unit 321 transmits, to a handoff source base station executing data communications, a RouteUpdate message (candidate base station notification) for setting base stations with one having a communication capability different from that of the base station executing the data communications to be handoff destination candidate base stations.

In addition, the data communication unit 321 receives a RAbit periodically transmitted from a radio base station supporting rev.0.

The handoff determination unit 323 determines whether or not a base station having a communication capability different from that of the handoff source base station is included in the handoff destination candidate base stations.

The communication rate setting unit 324 sets a communication rate in accordance to an application to be executed.

The random number generator 325 generates a random number x (0<x<1) periodically at a predetermined timing.

As will be described later, the random number/table comparison unit 326 refers to, on the basis of a random number x generated by the random number generator 325 and of a RAbit received periodically from a base station, a communication rate change test table stored in the communication rate change test table storage unit 331, and then notifies the communication rate setting unit 324 of the comparison result.

The communication rate change test table storage unit 331 stores, therein, all of or a part of the communication rate change test table 150 received from a radio base station.

The communication level storage unit 322 stores, therein, a communication level corresponding to an application.

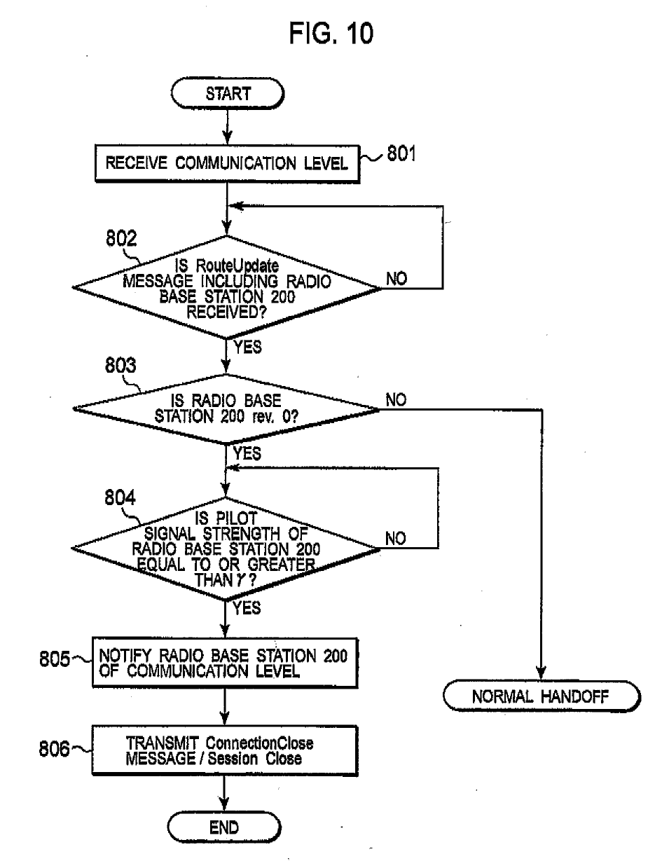

FIG. 10 is a flow chart showing details of an operation of the radio base station 100.

Upon starting communications with the radio communication terminal 300, the radio base station 100 receives, from the radio terminal 300, a communication level corresponding to a communication rate required for an application currently in execution, and then stores the communication level in the communication level storage unit 132.

The radio base station 100 determines whether or not a RouteUpdate message including the base station 200, that is, a RouteUpdate message indicating that the pilot signal strength of the radio base station 200 has become equal to or greater than a predetermined threshold value β is received (step 802). In a case where the RouteUpdate message is received (YES in step 802), the radio base station 100 determines whether or not the radio base station 200 supports only rev.0 (step 803).

In a case where the radio base station 100 determines that the radio base station 200 is not one supporting only rev. 0 (NO in step 803), the radio base station 100 performs a normal handoff procedure.

In a case where the radio base station 100 determines that the radio base station 200 supports only rev. 0 (YES in step 803), the radio base station 100 determines whether or not the pilot signal strength of the radio base station 200 has become equal to or greater than a predetermined threshold value γ (step 804).

In a case where the radio base station 100 receives the RouteUpdate message (YES in step 804), the radio base station 100 notifies the base station 200 of the communication level stored in the communication level storage unit 132 (step 805) . Moreover, the radio base station 100 transmits a ConnectionClose message to the radio communication terminal 300 (step 806) and ends the communications with the radio communication terminal 300.

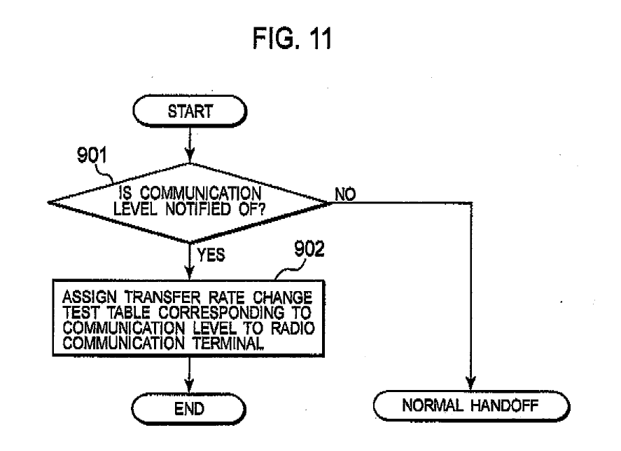

FIG. 11 is a flow chart showing details of an operation of the radio base station 200.

When the radio base station 200 is notified, by the radio base station 100, of the communication level of the application in execution in the communications with the radio communication terminal 300 (YES in step 901), the radio base station 200 refers to the communication rate change test table storage unit 133 in accordance with the notified communication level, and then extracts values corresponding to the communication level. Furthermore, the radio base station 200 generates a communication rate change test table 150′ on the basis of the extracted values (refer to FIG. 9), and then transmits the communication rate change test table 150′ to the radio communication terminal 300 when handoff of the radio communication terminal 300 is performed (step 902).

In a case where the radio base station 200 is notified of the communication level as “1,” for example, the radio base station 200 forms the communication rate change test table 150′ by extracting threshold values a corresponding to the level “1” in the communication rate change test table 150, as shown FIG. 7.

Thereafter, the radio base station 200 controls reverse link communications with the radio communication terminal 300 on the basis of the communication rate change test table 150′.

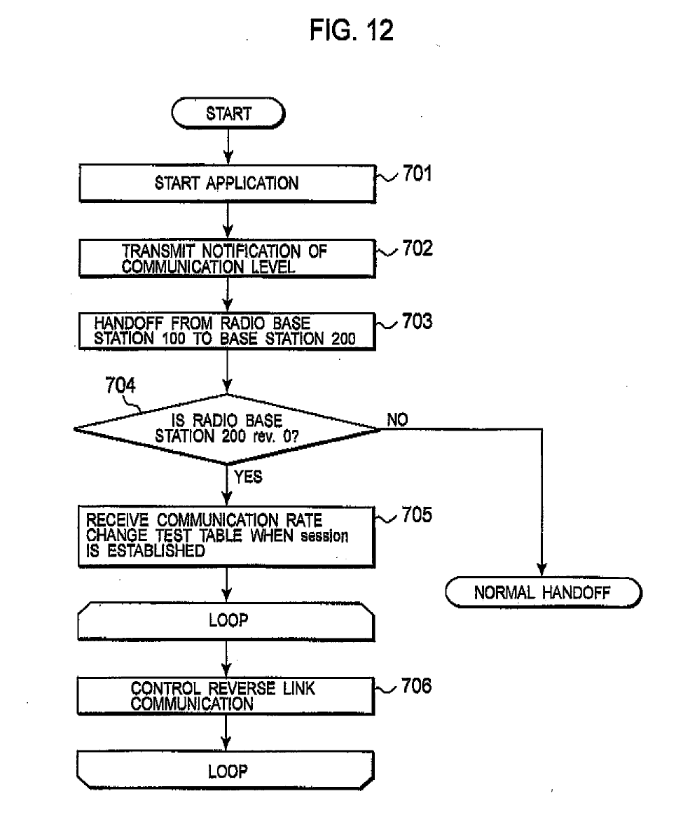

FIG. 12 is a flow chart showing details of an operation of the radio communication terminal 300.

Upon start of an application within the cell C100 supporting rev.A (step 701), the radio communication terminal 300 notifies the radio base station 100 of the communication level of the application (step 702).

Upon determination of handoff from the base station 100 to the base station 200 (step 703), the radio communication terminal 300 first determines whether or not the base station 200 is rev.0 (step 704). In a case where the radio communication terminal 300 determines that the base station 200 is rev.0 (YES in step 704), the radio communication terminal 300 receives the communication rate change test table 150′ from the radio base station 200 when a session is established (step 705), and controls the reverse link communication rate on the basis of the received communication rate change test table 150′ (step 706).

### Second Embodiment

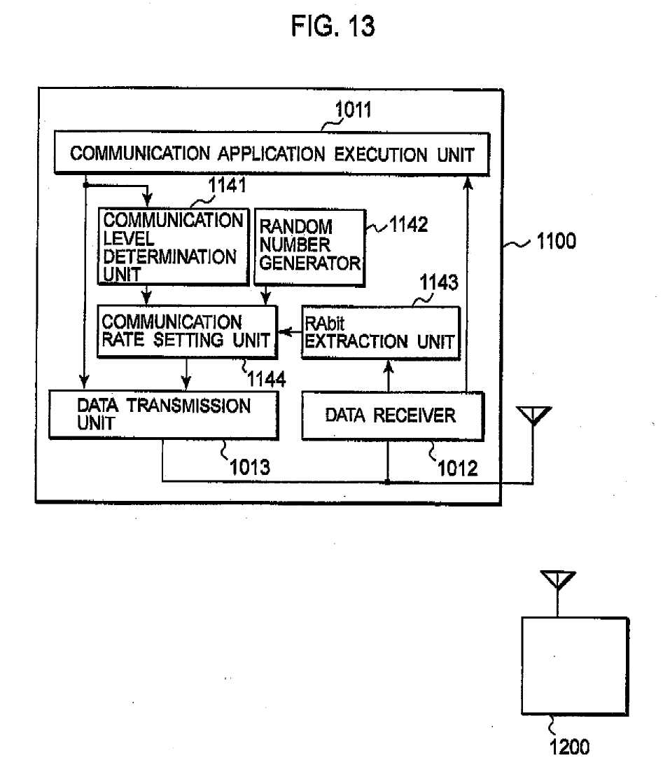

FIG. 13 is a block diagram showing a functional configuration of a radio communication terminal according to a second embodiment of the present invention.

A radio communication terminal 1100 is a terminal device supporting 1xEV-DO rev.A. A radio base station 1200 is a radio base station supporting 1xEV-DO.

The radio communication terminal 1100 is configured of: a communication application execution unit 1011 for executing an application such as an IP phone; a data receiver 1012 for receiving data from the radio base station 1200; and a data transmission unit 1013 for transmitting data from the radio communication terminal 1100 to the radio base station 1200. Furthermore, the radio communication terminal 1100 is provided with a communication level determination unit 1141, a random number generator 1142, a RAbit extraction unit 1143 and a communication rate setting unit 1144.

The data receiver 1012 demodulates a radio signal (RF signal) received from the radio base station 1200, then decodes the demodulated received data, and provides the data to the communication application execution unit 1011.

The RAbit extraction unit 1143 extracts, from the data receiver 1012, a RAbit periodically transmitted from the radio base station 1200 and then received by the data receiver 1012, and then provides the extracted RAbit to the communication rate setting unit 1144.

The communication level determination unit 1141 determines a communication rate required for an application to be executed by the communication application execution unit 1011, then sets a communication level in accordance with the determined communication rate, and then notifies the communication rate setting unit 1144 of the communication level.

The random number generator 1142 generates a random number x (0<x<1) periodically at a predetermined timing and then provides the generated random number to the communication rate setting unit 1144.

The communication rate setting unit 1144 includes a communication rate change test table 1150 to be described later, sets an upper limit value of a transmission rate of transmission data on the basis of the RAbit notified by the RAbit extraction unit 1143, the communication level notified by the communication level determination unit 1141 and the random number x provided by the random number generator 1142, and then notifies the data transmission unit 1013 of the set upper limited value of the communication rate.

The data transmission unit 1013 encodes, on the basis of the upper limit value notified by the communication rate setting unit 1144, data received from the communication application execution unit 1011, then modulates the data and outputs the data as an RF signal.

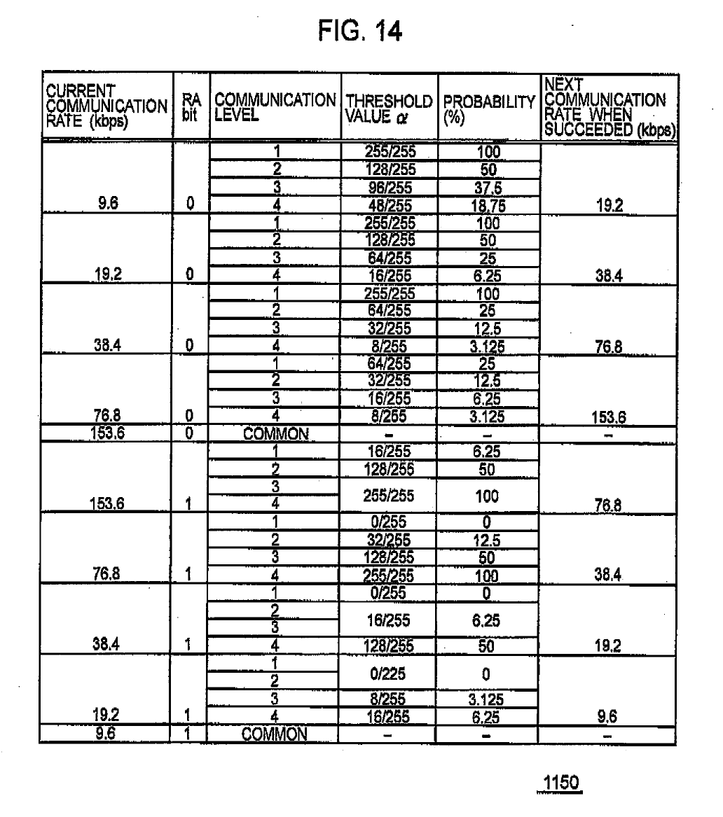

FIG. 14 is the communication rate change test table 1150 included in the communication rate setting unit 1144 of the radio communication terminal 1100.

The communication rate change test table 1150 is different from a conventional communication rate change test table in a point that a plurality of communication levels are provided in association with each of upper limit values respectively of reverse link communication rates, and a threshold value of the aforementioned probability test is provided for each of the communication levels.

Note that each of the communication levels is a value to be set on the basis of a communication rate determined by the communication level determination unit 1141. In this embodiment, values at four phases from 1 to 4 are set for each of the upper limit values of the respective communication rates. The method of setting the communication levels is not limited to this, however. The values may be set at three phases for each of the upper limit values of the respective communication rates. Moreover, a different phase may be set for each of the upper limit values (four levels for 9.6 kbps, three levels for 19.2 kbps, and the like, for example). As a matter of course, the values of threshold values α are not limited to the values used in this embodiment.

Furthermore, in this embodiments a communication level is set in the communication level determination unit 1141 and then provided to the communication rate setting unit 1144. The communication level determination unit 1141 may notify the communication rate setting unit 1144 of the communication rate required for the application, and the communication rate setting unit 1144 may set the communication level on the basis of the notification.

According to the communication rate change test table 1150, in a case where the communication level of an application is determined to be “1” while RAbit=0 (in other words, in a case where it is possible to increase the communication rate), the upper limit of the communication rate is always increased to 19.2 kbps, which is the next level, since the threshold value α corresponding to the communication level “1” at 9.6 kbps is “255/255”, for example, and thus α≧x(0<x<1) becomes always true (probability 100%). Likewise, since the threshold value α at 19.2 kbps and 38.4 kbps is “255/255” in a case where the communication level is “1,” the upper limit value is always increased to the next level.

Specifically, according to the communication rate change test table 1150, for an application whose communication level is defined and set to be “1,” the upper limit value of the communication rate is surely increased to 76.8 kbps after a test is performed three times.

In addition, in a case where RAbit=1 as well (in a case where it is not preferable to increase the communication rate) and where the communication level of the application is “1,” the communication rate can be maintained at 76.8 kbps since the threshold value α corresponding to the communication level “1” at 76.8 kbps is always “0/255,” and thus α<x(0<x<1) is always true (probability 100%).

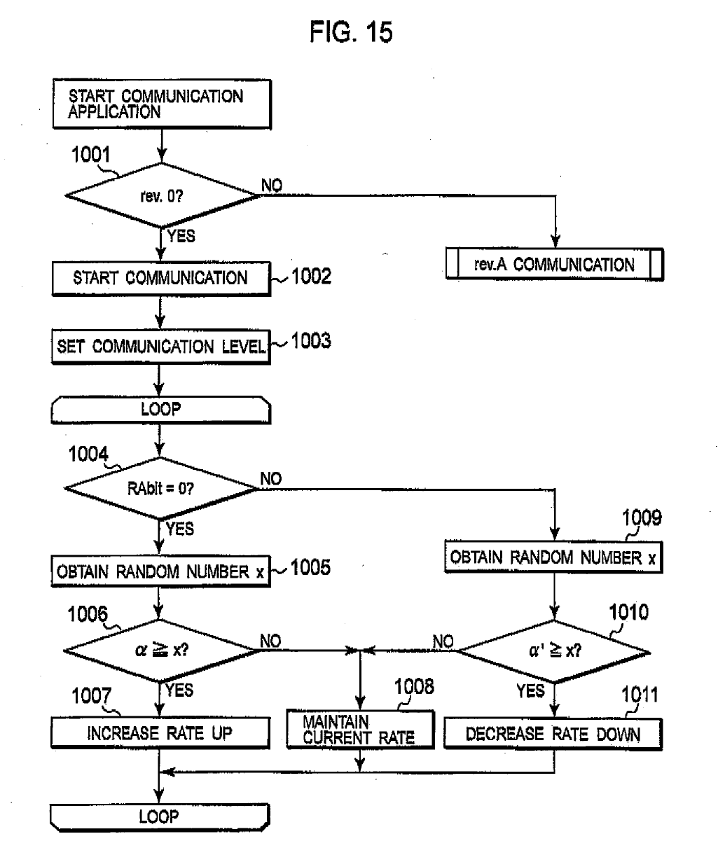

FIG. 15 is a flow chart showing communication rate setting processing performed by the radio communication terminal 1100 according to the present embodiment.

Upon start of an application in the communication application execution unit 1011, the radio communication terminal 1100 first determines whether the radio communication terminal 1100 is in an environment in accordance with 1xEV-DO (hereinafter, referred to as rev.0) or in an environment in accordance with 1xEV-DO rev.A (hereinafter, referred to as rev.A) (step 1001). In a case where the radio communication terminal 1100 determines that the radio communication terminal 1100 is in an environment in accordance with rev.A (NO in step 1001), the radio communication terminal 1100 starts communications after going through a predetermined procedure (the description thereof is omitted since the procedure is not related to the present invention).

On the other hand, in a case where the radio communication terminal 1100 determines that the radio communication terminal 1100 is in an environment in accordance with Rev.0 (YES in step 1001), the radio communication terminal 1100 starts communications at the lowest communication rate (9.6 kbps) (step 1002). Moreover, the radio communication terminal 1100 (the communication level determination unit 1141) determines a reverse link communication rate required for the application, then sets an appropriate communication level, and notifies the communication rate setting unit 1144 of the communication level (step 1003). Upon receipt of a RAbit from a radio base station, the radio communication terminal 1100 determines whether or not the received RAbit is “0” (step 1004).

In a case where the radio communication terminal 1100 determines that the received RAbit is “0” (YES in step 1004), the radio communication terminal 1100 operates to increase the upper limit value of the current communication rate by one level. The radio communication terminal 1100, specifically, the random number generator 1142 generates a random number x (0<x<1) and provides it to the communication rate setting unit 1144 (step 1005). The communication rate setting unit 1144 compares a threshold value α corresponding to the upper limit value (9.6 kbps at the start of communications) of the current communication rate and to the communication level notified by the communication level determination unit 1141 with the random number x (step 1006).

In a case where the communication rate setting unit 1144 determines that the random number x is smaller than the threshold value α (YES in step 1006), the communication rate setting unit 1144 increases the upper limit value of the current communication rate by one level (step 1007). On the other hand, in a case where the communication rate setting unit 1144 determines that the random number x is equal to or greater than the threshold value α (NO in step 1006), the communication rate setting unit 1144 maintains the upper limit value of the current communication rate (step 1008).

In addition, in a case where the radio communication terminal 1100 determines that the RAbit is “1” (NO in step 1004), the radio communication terminal 1100 operates to decrease the upper limit value of the current communication rate by one level. The radio communication terminal 1100, specifically, the random number generator 1142 generates a random number x (0<x<1) and provides it to the communication rate setting unit 1144 (step 1009). The communication rate setting unit 1144 compares a threshold value α (denoted by α′ in the drawings in order to distinguish the threshold value α from a threshold value α when a RAbit is “0”) corresponding to the upper limit value of the current communication rate and to the communication level notified by the communication level determination unit 141 with the random number x (step 1010).

In a case where the communication rate setting unit 1144 determines that the random number x is smaller than the threshold value α (YES in step 1006), the communication rate setting unit 1144 decreases the upper limit value of the current communication rate by one level (step 1007). In a case where the communication rate setting unit 1144 determines that the random number x is equal to or greater than the threshold value α (NO in step 1006), the communication rate setting unit 1144 maintains the upper limit value of the current communication rate (step 1008).

Note that the radio communication terminal 1100 may notify the radio base station 1200 of the communication level set by the communication level determination unit 1141. The radio base station 1200 is thereby allowed to understand the status of each of the radio communication terminals and then to utilize the information for traffic controls or the like.

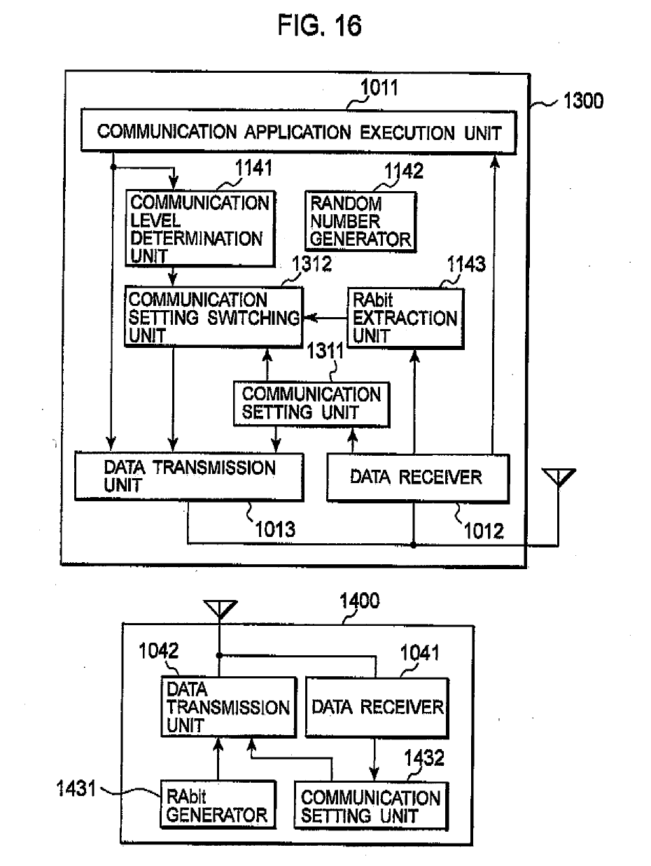

FIG. 16 is a block diagram showing a functional configuration of a radio communication terminal and a radio base station according to a modification example of the present embodiment.

A radio communication terminal 1300 is a terminal device supporting rev.A. A radio base station 1400 is a radio base station supporting rev.0.

The radio communication terminal 1300 is configured of: a communication application execution unit 1011 for executing an application such as an IP phone; a data receiver 1012 for receiving data from the radio base station 1400; and a data transmission unit 1013 for transmitting data from the radio communication terminal 1300 to the radio base station 1400. Moreover, the radio communication terminal 1300 is provided with a communication level determination unit 1141, a random number generator 1142, a RAbit extraction Unit 1143, a communication setting unit 1311 and a communication setting switching unit 1312.

In addition, the radio base station 1400 is configured of a data receiver 1041 for receiving data from a radio communication terminal or the like, and of a data transmission unit 1042 for transmitting data to a radio communication terminal or the like. The radio communication terminal 1400 further includes a RAbit generator 1431 and a communication setting unit 1432.

In the radio communication terminal 1300, the data receiver 1012 demodulates a radio signal (RF signal) received from a radio base station, then decodes the demodulated receiving data, and provides the data to the communication application execution unit 1011.

The communication setting unit 1311 performs a communication setting between itself and the radio base station 1400 when power is supplied to the radio communication terminal 1300.

Here, the communication setting unit 1311 sets a plurality of communication settings respectively for the aforementioned communication levels between itself and the radio base station 1400.

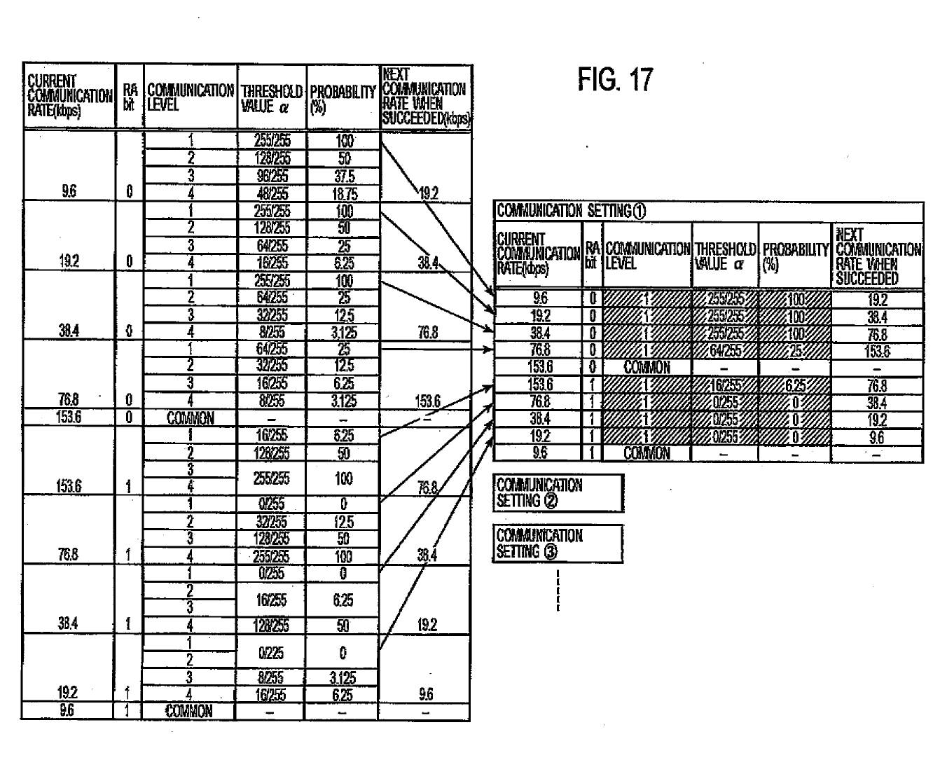

Specifically, as shown in FIG. 17, the communication setting unit 1311 extracts a threshold value α corresponding to the communication level “1” at each of the phases from the communication rate change test table 1150 and then forms a communication setting (1) as the communication setting corresponding to the communication level “1”, for example. Likewise, the communication setting unit 1311 configures a communication setting (2) as the communication setting corresponding to the communication level “2,” a communication setting (3) as the communication setting corresponding to the communication level “3,” and so on, and repeatedly configures a setting between itself and the radio base station 1400 until the number of communication settings becomes equal to the number of communication levels. A plurality of communication settings obtained as the result of this processing are retained in the communication setting switching unit 1312.

The communication setting switching unit 1312 stores and retains the communication settings for the respective communication levels, which are set in the communication setting unit 1311, and then switches the communication setting between itself and the radio base station 1400 to an appropriate communication setting in accordance with the communication level notified by the communication level determination unit 1141.

On the other hand, in the radio base station 1400, the data receiver 1041 receives data from the radio communication terminal 1300 or the like, and the data transmission unit 1042 transmits data to the radio communication terminal 1300 or the like.

The RAbit generator 1431 generates a RAbit showing an instruction to increase or to decrease a communication rate depending on communication congestions or the like.

The communication setting unit 1432 establishes and stores a plurality of communication settings between itself and the radio communication terminal 1300 when power is supplied to the radio communication terminal 1300.

Specifically, in this embodiment, during a normal communication setting performed between itself and the radio base station 1400 when power is supplied to the radio communication terminal 1300, the radio communication terminal 1300 sets a plurality of communication settings including the optimum threshold values α defined for the respective communication rates of each of the communication levels. In addition, the radio communication terminal 1300 uses the communication settings while switching the communication settings from one to another in accordance with the communication level of a communication application to be started.

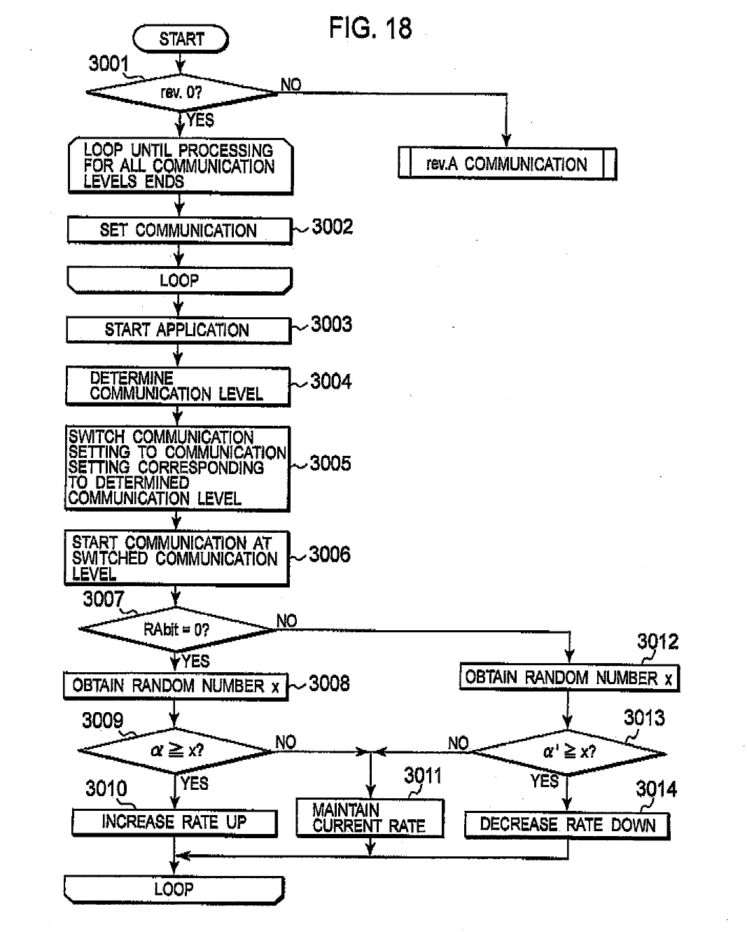

FIG. 18 is a flow chart showing an operation of the radio communication terminal 1300 according to the modification example.

When power is turned on, the radio communication terminal 1300 first sets, in the communication setting unit 1311, the aforementioned plurality of communication settings for the respective communication levels between itself and the base station 400 (step 3002).

Upon starting of a communication application by the communication application execution unit 1011 (step 3003), the radio communication terminal 1300, specifically, the communication level determination unit 1141 determines a communication level of the application (step 3004), and then provides the determined communication level to the communication setting switching unit 1312.

The communication setting switching unit 1312 selects an appropriate communication setting from the plurality of communication settings on the basis of the communication level notified by the communication level determination unit 1141 (step 3005). The radio communication terminal 1300 begins communications by use of the selected communication setting (step 3006).

Upon receipt of a RAbit from the radio base station 1400, the radio communication terminal 1300 determines whether or not the received RAbit is “0” (step 3007). In a case where the radio communication terminal 1300 determines that the received RAbit is “0” (YES in step 3007), the radio communication terminal 1300 operates to increase the upper level value of the current communication rate by one level. The radio communication terminal 1300, specifically, the random number generator 1142 generates a random number x (0<x<1) and provides it to the communication setting switching unit 1312 (step 3008).

Moreover, the communication setting switching unit 1312 compares a threshold value α corresponding to the upper limit value (9.6 kbps at the start of communications) of the current communication rate with the random number x (step 3009). In a case where the communication setting switching unit 1312 determines that the random number x is smaller than the threshold value α (YES in step 3009), the communication setting switching unit 1312 increases the upper limit value of the current communication rate by one level (step 3010). On the other hand, in a case where the communication setting switching unit 1312 determines that the random number x is equal to or greater than the threshold value α, the communication setting switching unit 1312 maintains the upper limit value of the current communication rate (step 3011).

Moreover, in a case where the radio communication terminal 1300 determines that the RAbit is “1” (NO in step 3007) the radio communication terminal 1300 operates to decrease the upper limit value of the current communication rate by one level. The radio communication terminal 1300, specifically, the random number generator 1142 generates a random number x (0<x<1) and provides it to the communication setting switching unit 1312 (step 3012). The communication setting switching unit 1312 compares a threshold value α (denoted by α′ in the drawing in order to distinguish the threshold value α from a threshold value α when a RAbit is “0”) corresponding to the upper limit value of the current communication rate and to the communication level notified by the communication level determination unit 1141 with the random number x (step 3013). In a case where the communication setting switching unit 1312 determines that the random number x is smaller than the threshold value α (YES in step 3013), the communication setting switching unit 1312 decreases the upper limit value of the current communication rate by one level (step 3013). On the other hand, in a case where the communication setting switching unit 1312 determines that the random number x is equal to or greater than the threshold value α, the communication setting switching unit 1312 maintains the upper limit value of the current communication rate (step 3014).

According to the present embodiment described above, during a communication setting when power is turned on, a plurality of communication settings including the optimum threshold values α defined for the respective communication rates of each of the communication levels are set. At the time of starting an application, the optimum communication environment can be thus provided without adding a load to the processing by simply selecting an optimum communication setting for the application at the time of starting the application.

### Third Embodiment

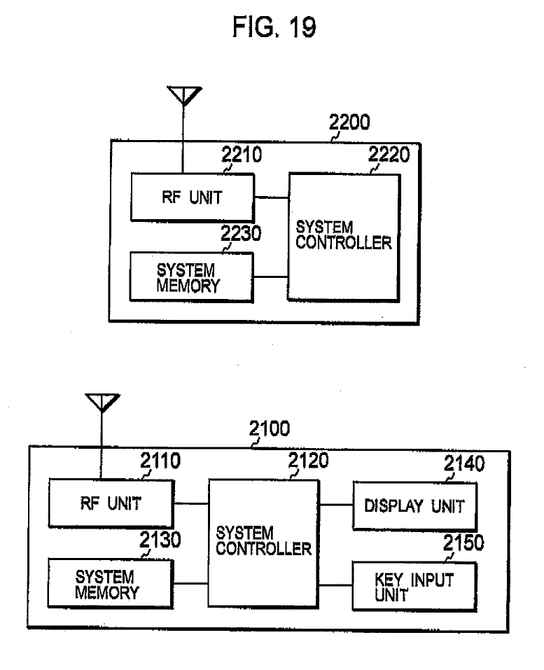

FIG. 19 is a schematic block configuration diagram of a radio communication terminal and a radio base station according to a third embodiment of the present invention.

In FIG. 19, a radio communication terminal 2100 is a terminal device supporting both rev.A and rev.0 and is provided with an REF unit 2110, a system controller 2120, a system memory 2130, a display unit 2140 and a key input unit 2150.

The RF unit 2110 transmits and receives a radio signal in accordance with CDMA to and from a radio base station 2200. The RF unit 2110 demodulates the radio signal and transmits the demodulated received data to the system controller 2120 while modulating data received from the system controller 2120 and then transmitting the data to the radio base station 2200 as a radio signal.

The system controller 2120 controls various types of functions included in the radio communication terminal 2100. A description of a functional block configuration of the system controller 2120 according to the present embodiment will be given later in more detail.

The system memory 2130 stores, therein, various types of information used in a control or the like in the radio communication terminal 2100. A description of a functional block configuration of the system memory 2130 according to the present embodiment will be given later in more detail.

The display unit 2140 displays image contents or the like received via the RF unit 2110 and the system controller 2120, or displays operation contents (an input phone number, address or the like).

The key input unit 2150 is configured of a ten key, function keys, or the like and is an interface used for inputting operation contents by the user.

Moreover, the radio base station 2200 is a base station supporting only rev.0 and is provided with an RF unit 2210, a system controller 2220 and a system memory 2230.

The RF unit 2210 transmits and receives a radio signal in accordance with CDMA to and from the radio communication terminal 2100. In addition, the RF unit 2210 executes conversion of the radio signal into a baseband signal, and transmits and receives a baseband signal to and from the system controller 2220.

The system controller 2220 controls various types of functions included in the radio base station 2200. A description of a functional block configuration of the system controller 2220 according to the present embodiment will be given later in more detail.

The system memory 2230 stores, therein, various types of information used in a control or the like in the radio base station 2200. A description of a functional block configuration of the system memory 2230 according to the present embodiment will be given later in more detail.

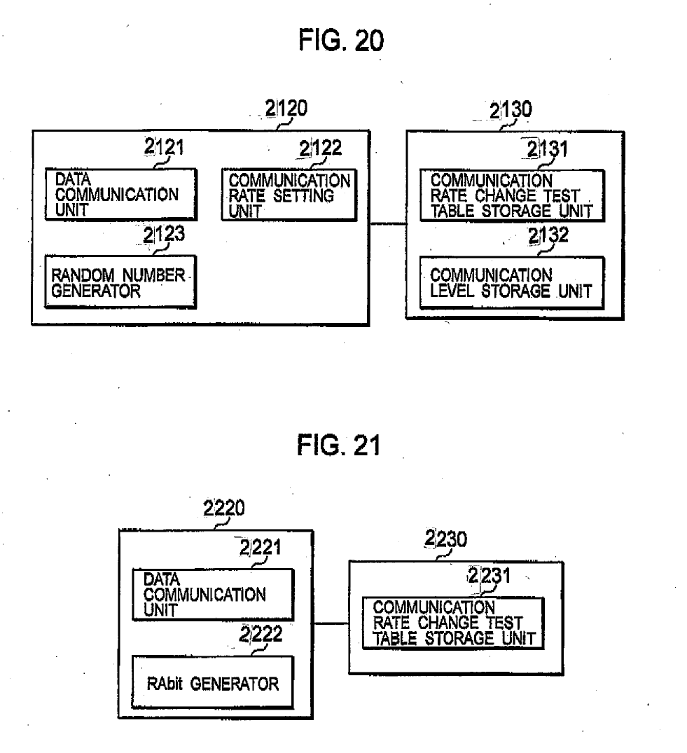

FIG. 20 is a detailed functional block configuration diagram of the system controller 2120 and the system memory 2130.

As shown in FIG. 20, the system controller 2120 is provided with a data communication unit 2121, a communication rate setting unit 2122 and a random number generator 2123.

Moreover, the system memory 2130 is provided with a communication rate change test table storage unit 2131 and a communication level storage unit 2132.

The data communication unit 2121 receives a RAbit transmitted periodically from the radio base station 2200.

The communication rate setting unit 2122 sets a communication rate in accordance with an application to be executed as will be described later.

The random number generator 2123 generates a random number x (0<x<1) periodically at a predetermined timing.

The communication rate change test table storage unit 2131 stores, therein, a communication rate change test table 2350 to be described later.

The communication level storage unit 2132 stores, therein, communication levels corresponding to applications respectively.

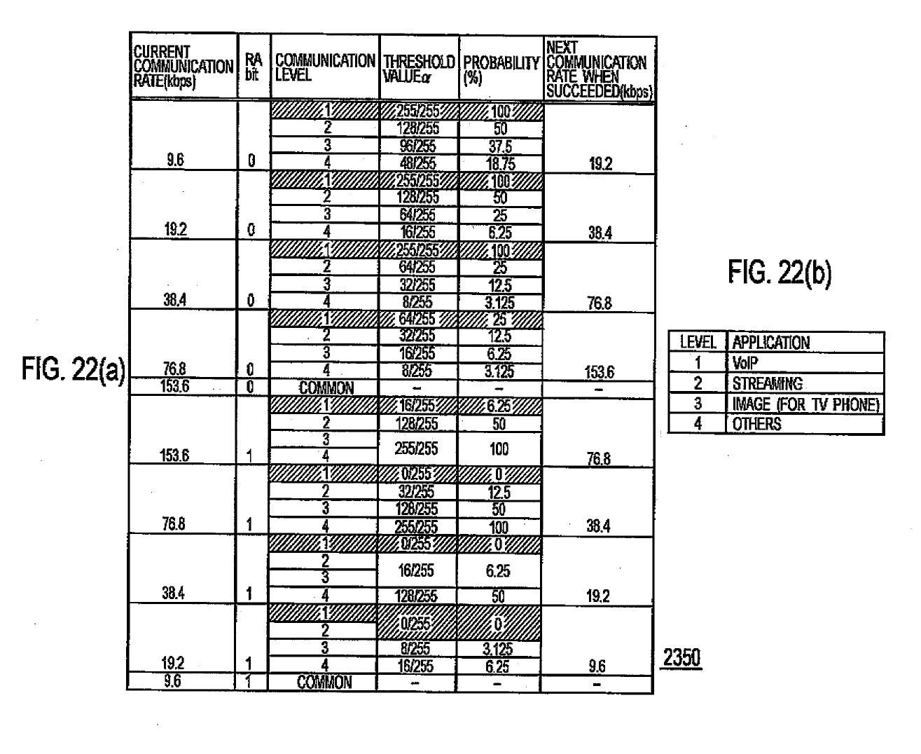

Here, the communication rate change test table 2350 stored in the communication rate change test table storage unit 2131 is shown in FIG. 22.

In FIG. 22(a), the communication rate change test table 2350 is different from a conventional communication rate change test table in a point that a plurality of communication levels are provided in association with each of upper limit values respectively of reverse link communication rates, and a threshold value of the aforementioned probability test is provided for each of the communication levels.

Note that the communication level is a value stored in accordance with an application in the communication level storage unit 2132, that is, a value stored on the basis of a reverse link communication rate required for the application (refer to FIG. 22(b)).

According to the communication rate change test table 2350, in a case where the communication level of an application is determined to be “1” (VoIP or the like, for example) while RAbit=0 (in other words, in a case where it is possible to increase the communication rate), the threshold value α corresponding to the communication level “1” at 9.6 kbps is “255/255,” for example, and α>x(0<x<1) becomes always true (probability 100%). For this reason, the upper limit of the communication rate is always increased to 19.2 kbps, which is the next level. Likewise, at 19.2 kbps and 38.4 kbps, since the threshold value α in a case where the communication level is “1” is “255/255,” the upper limit value is always increased to the next level.

Specifically, according to the communication rate change test table 2350, for an application whose communication level is set to “1,” the upper limit value of the communication rate is surely increased to 76.8 kbps after a test is performed three times.

Moreover, in a case where RAbit=1 as well (in a case where it is not preferable to increase the communication rate) and where the communication level of the application is “1,” the communication rate can be maintained at 76.8 kbps since the threshold value α corresponding to the communication level “1” at 76.8 kbps is always “0/255, ” for example, and thus α<x (0<x<1) is always true (probability 100%).

Not that, in this embodiment, values at four phases from 1 to 4 for each of the upper limit values of the respective communication rates are set in the communication rate change test table 2350. The method of setting the communication levels is not limited to this, however. The values may be set at three phases for each of the upper limit values of the respective communication rates. Moreover, a different phase may be set for each of the upper limit values (four levels for 9.6 kbps, three levels for 19.2 kbps, and the like, for example). As a matter of course, the values of threshold values α are not limited to the values used in this embodiment.

FIG. 21 is a functional block configuration diagram of a system controller 2220 and a system memory 2230 of the radio base station 2200.

As shown in FIG. 21, the system controller 2220 is provided with a data communication unit 2221 and a RAbit generator 2222.

Moreover, the system memory 2230 is provided with a communication rate change test table storage unit 2231.

The data communication unit 2221 executes processing related to communications for image contents, music contents or the like or transmission or receipt of various types of control information.

The RAbit generator 2222 generates a RAbit having any one of values “0” and “1” depending on network congestions of the radio base station 2200 and of a peripheral base station.

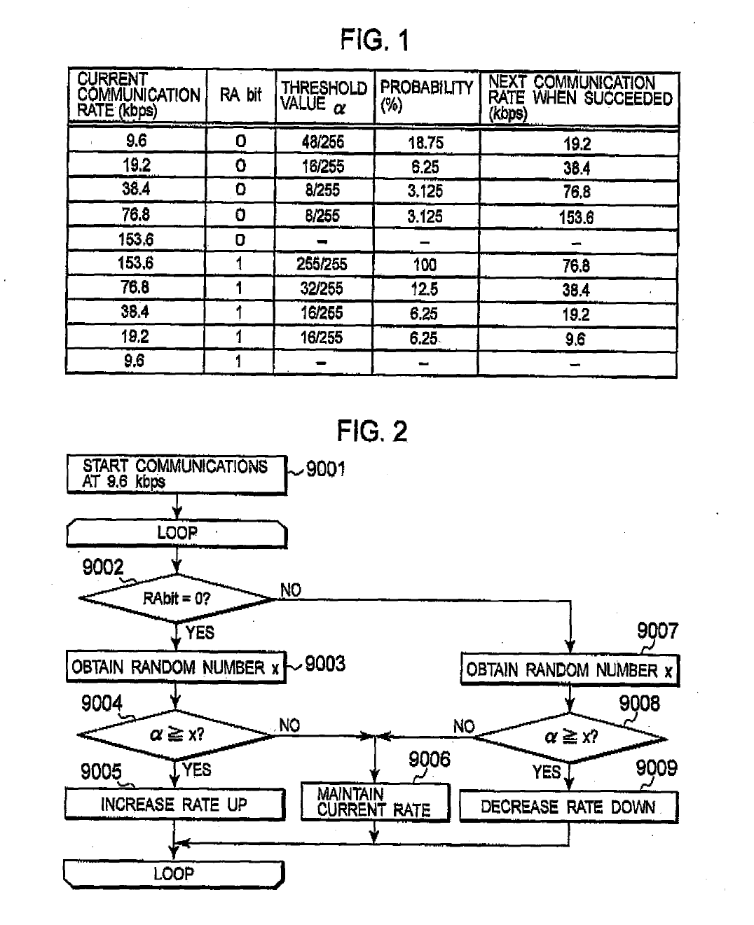

The communication rate change test table storage unit 2231 stores, therein, a conventional communication rate change test table (refer to FIG. 1).

Specifically, in this embodiment, differences between the communication rate change test table retained by the radio communication terminal 2100 and the communication rate change test table retained by the radio base station 2200 are the numbers of and values of threshold values set for the respective upper limit values of each of the reverse link communication rates.

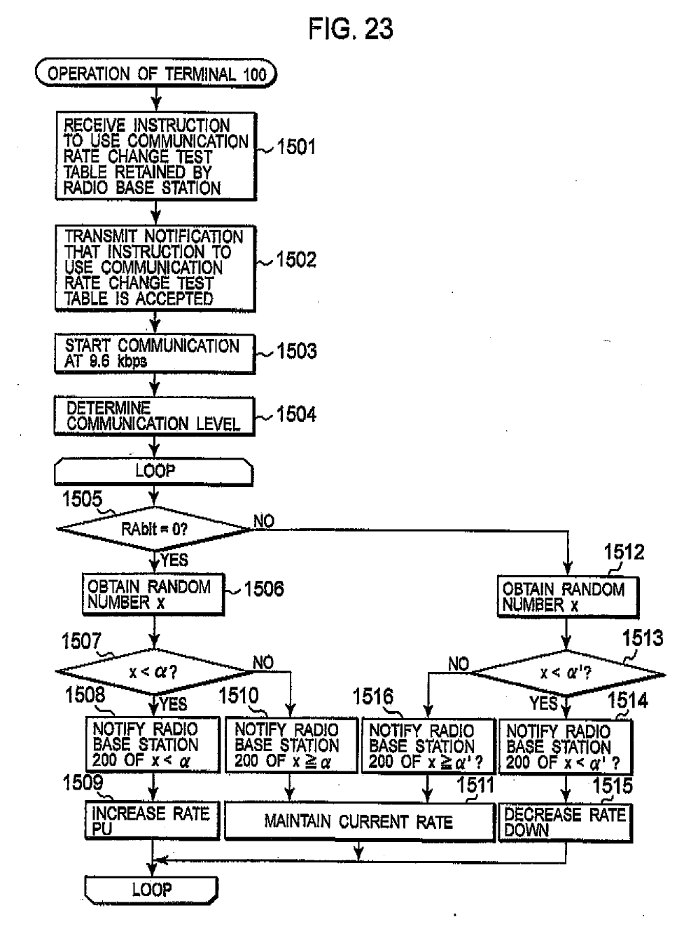

FIG. 23 is a flowchart showing an operation of the radio communication terminal 2100 in detail.

The radio communication terminal 2100 checks, at the time of establishing a session with the radio base station 2200, which communication rate change test table is to be used. Specifically, in a case where the radio communication terminal 2100 receives, from the radio base station 2200, an instruction to use threshold values in accordance with the communication rate change test table (refer to FIG. 1) retained in the radio base station 2200 (step 1501), the radio communication terminal 2100 transmits to the radio base station 2200 a signal indicating that the instruction is accepted (step 1502).

Actually, the radio communication terminal 2100 performs a control using (threshold values of) the communication rate change test table 2350 retained in its own the communication rate change test table storage unit 2131, however.

Thereafter, the radio communication terminal 2100 first starts communications at the lowest communication rate (9.6 kbps) (step 1503).

The radio communication terminal 2100, specifically, the communication rate setting unit 2122 determines, on the basis of the communication level storage unit 2132, a communication level appropriate for an application to be executed (step 1504) .

Subsequently, upon receipt of a RAbit from the radio base station 2200, the communication rate setting unit 2122 determines whether or not the received RAbit is “0” (step 1505).

In a case where the communication rate setting unit 2122 determines that the received RAbit is “0” (YES in step 1505), the communication rate setting unit 2122 operates to increase the upper level value of the current reverse link communication rate by one level on the basis of the communication rate change test table 2350 stored in the communication rate change test table storage unit 2131.

Next, the radio communication terminal 2100, specifically, the random number generator 2123 generates a random number x (0<x<1) and provides it to the communication rate setting unit 2122 (step 1506). The communication rate setting unit 2122 obtains a threshold value α corresponding to the upper limit value (9.6 kbps at the start of communications) of the current reverse link communication rate and to the communication level determined in step 1504 from the communication rate change test table 2350 and then compares the obtained threshold value α with the random number x (step 1507).

In a case where the communication rate setting unit 2122 determines that the random number x is smaller than the threshold value α (YES in step 1507), the communication rate setting unit 2122 notifies the radio base station 2200 that “x<α” (step 1508) and then increases the upper limit value of the current reverse link communication rate by one level (step 1509).

On the other hand, in a case where the communication rate setting unit 2122 determines that the random number x is equal to or greater than the threshold value α (NO in step 1507), the communication rate setting unit 2122 notifies the radio base station 2200 that “x≧α” (step 1510) and maintains the upper limit value of the current reverse link communication rate (step 1511).

In addition, in a case where the communication rate setting unit 2122 determines that the RAbit is “1” (NO in step 1505), the communication rate setting unit 2122 operates to decrease the upper level value of the current reverse link communication rate by one level on the basis of the communication rate change test table 2350 stored in the communication rate change test table storage unit 2131.

Specifically, the random number generator 2123 generates a random number x (0<x<1) and provides it to the communication rate setting unit 2122 (step 1512). The communication rate setting unit 2122 obtains a threshold value α corresponding to the upper limit value of the current reverse link communication rate and to the communication level determined in step 1504 from the communication rate change test table 2350 and then compares the obtained threshold value α (denoted by α′ in the drawing in order to distinguish the threshold value α from a threshold value α when a RAbit is “0”) with the random number x (step 1513).

In a case where the communication rate setting unit 2122 determines that the random number x is smaller than the threshold value α (YES in step 1513), the communication rate setting unit 2122 notifies the radio base station 2200 that “x<α” (step 1514) and decreases the upper limit value of the current reverse link communication rate by one level (step 1515).

On the other hand, in a case where the communication rate setting unit 2122 determines that the random number x is equal to or greater than the threshold value α (NO in step 1513), the communication rate setting unit 2122 notifies the radio base station 2200 that “x≧α” (step 1516) and maintains the upper limit value of the current reverse link communication rate (step 1511).

Note that in steps 1508, 1510, 1514 and 1516, the radio communication terminal 2100 does not notify the radio base station 2200 of the values of “x” and “α” themselves, and rather notifies the radio base station 2200 of only a magnitude relationship between the two. Specifically, the radio communication terminal 2100 notifies the radio base station 2200 of a value indicating a magnitude relationship between “x” and “α” such as “x/α” (value obtained by dividing x by α) or “x-α” (value obtained by subtracting α from x), for example.

Upon receipt of a value indicating a magnitude relationship between “x” and “α” from the radio communication terminal 2100, the radio base station 2200 changes the upper limit value of the reverse link communication rate on the basis of the received value.

Specifically, in a case where the RAbit is “0,” for example, the radio base station 2200 operates to increase the upper limit value of the current reverse link communication rate by one level. Then, when the radio base station 2200 is notified of the value of “x/α,” for example, by the radio communication terminal 2100 as a value indicating a magnitude relationship between “x” and “α,” the radio base station 2200 increases the upper limit value of the reverse link communication rate by one level if “1>(x/α)” (that is, x<α) is true. Moreover, the radio base station 2200 maintains the upper limit value of the current reverse link communication rate in this case if “1≦(x/α)” (that is, x≧α) is true.

Furthermore, in a case where the RAbit is “1,” the radio base station 2200 operates to decrease the upper limit value of the current reverse link communication rate by one level. Then, when the radio base station 2200 is notified of the value of “x/α,” for example, by the radio communication terminal 2100 as a value indicating a magnitude relationship between “x” and “α,” the radio base station 2200 decreases the upper limit value of the reverse link communication rate by one level if “1>(x/α)” (that is, x<α) is true. Moreover, the radio base station 2200 maintains the upper limit value of the current reverse link communication rate in this case if “1≦(x/α)” (that is, x≧α) is true.

Note that in the aforementioned embodiment, the configuration in which the radio communication terminal 2100 notifies the radio base station 2200 of a magnitude relationship between a random number x and a threshold value α is employed. However, a configuration in which the radio base station 2200 is simply provided with an instruction to increase or decrease an upper limit value of a reverse link communication rate by one level or to maintain the upper limit value of the reverse link communication rate may be employed. In this case, the radio base station 2200 changes the upper limit value of the reverse link communication rate in accordance with the instruction from the radio base station 100.

According to the present embodiment described above, an upper limit value of a reverse link communication rate in accordance with an application can be controlled by the radio communication terminal 2100 without adding a change in an reverse link communication control performed by the radio base station 2200 as a base station supporting rev. 0.

Note that the entire contents of Japanese Patent Application No. 2005-342176 (filed on Nov. 28, 2005), Japanese Patent Application No. 2005-342180 (filed on Nov. 28, 2005) and Japanese Patent Application No. 2005-366233 (filed on Dec. 20, 2005) are incorporated in this description herein by reference.

### INDUSTRIAL APPLICABILITY

As has been described so far, since it is possible to shorten a duration of communication disconnection in handoff, a communication method, a mobile terminal and a base station according to the present invention are advantageous in radio communications such as mobile communications in a case where a mixture of devices having different communication capabilities related to data communications exist.

1. A radio communication terminal comprising:
a storage unit configured to store a plurality of threshold values for changing an upper limit value of a communication rate, for each of the upper limit value set in a stepwise manner; and
a controller configured to select, in accordance with an application to be executed, threshold values corresponding to a reverse link communication rate required for the application from the storage unit, and to control a reverse link communication rate of the application on the basis of the selected threshold values.

2. A radio communication terminal comprising:
a setting unit configured to set, for a radio base station, a plurality of communication settings defining an optimum value of each application as a threshold value for changing an upper limit value of a communication rate, for each of the upper limit value set in a stepwise manner; and
a controller configured to control a reverse link communication rate to the radio base station, by use of the communication settings in accordance with an application to be started.

3. The radio communication terminal according to claim 1, wherein the controller notifies a radio base station of the threshold values selected in accordance with a reverse link communication rate required for the application, when executing the application.

4. A radio communication method comprising:
providing a plurality of threshold values for changing an upper limit value of a communication rate, for each of the upper limit value set in a stepwise manner;
selecting, in accordance with an application to be executed by a radio communication terminal, the threshold values corresponding to a reverse link communication rate required for the application; and
controlling a reverse link communication rate of the application on the basis of the selected threshold values.

5. A radio communication method comprising:
setting, for a radio base station, a plurality of communication settings defining an optimum value of each application as a threshold value for changing an upper limit value of a communication rate, for each of the upper limit value set in a stepwise manner; and
controlling a reverse link communication rate to the radio base station, by use of the communication settings in accordance with an application to be started.

6. A radio communication terminal comprising:
a storage unit configured to store a threshold value for changing an upper limit value of a communication rate, for each of the upper limit value set in a stepwise manner, while associating the threshold value with an application; and
a controller configured to select the threshold value associated with the application in accordance with the application to be executed, and to control a reverse link communication rate of the application on the basis of the selected threshold value.

7. The radio communication terminal according to claim 6, further comprising:
a receiver configured to receive a threshold value set in a radio base station from the radio base station, the threshold value being used for changing an upper limit value of a communication rate, for each of the upper limit value; and
a notification unit configured to notify the radio base station that the threshold value received by the receiver is used for controlling a reverse link communication rate by the controller.

8. A radio communication method comprising:
storing a threshold value for changing an upper limit value of a communication rate, for each of the upper limit value set in a stepwise manner, while associating the threshold value with an application;
receiving a threshold value set in a radio base station from the radio base station, the threshold value being used for changing an upper limit value of the communication rate, for each of the upper limit value set in a stepwise manner;
notifying the radio base station that the received threshold value is used for controlling a reverse link communication rate, while selecting, in accordance with an application to be executed, the threshold value stored in association with the application; and
controlling a reverse link communication rate of the application on the basis of the selected threshold value.

9. A radio base station configured to perform radio communication with a radio communication terminal, comprising:
a storage unit configured to store a plurality of threshold values for changing an upper limit value of a communication rate, for each of the upper limit value set in a stepwise manner;
a receiver configured to receive, from a different radio base station, information indicating a reverse link communication rate required for an application executed by the radio communication terminal that performs radio communication with the different radio base station; and
a notification unit configured to obtain, from the storage unit, the threshold values corresponding to information which is received by the receiver and indicates a reverse link communication rate required for the application, and to notify the radio communication terminal of the selected threshold values when handoff of the radio communication terminal is performed from the different radio base station to the radio base station.

10. A radio base station configured to perform radio communication with a radio communication terminal, comprising:
a receiver configured to receive, from the radio communication terminal, information indicating a reverse link communication rate required for an application executed by the radio communication terminal; and
a notification unit configured to notify a different radio base station of information which is received by the receiver and indicates a reverse link communication rate required for an application executed by the radio communication terminal, when handoff of the radio communication terminal is performed from the radio base station to a different radio base station.

11. A radio communication terminal comprising:
a transmitter configured to transmit, to a radio base station, information indicating a reverse link communication rate required for an application to be executed;
a receiver configured to receive a threshold value from a radio base station in communication when handoff is performed from the radio base station in the communication to a different radio base station, the threshold value being determined for each of an upper limit value of a communication rate and being used for changing the upper limit value set in a stepwise manner; and
a controller configured to control a reverse link communication rate of the application on the basis of the threshold value received by the receiver.

12. A radio communication system comprising:
a first radio base station capable of allocating a desired reverse link communication rate in accordance with an application;
a second radio base station configured to control a reverse link communication rate of the application by changing an upper limit value of the reverse link communication rate in a stepwise manner; and
a radio communication terminal capable of communicating with the first radio base station and the second radio base station, wherein
the first radio base station includes:
a receiver configured to receive information indicating a reverse link communication rate required for the application when the radio communication terminal executes the application; and
a notification unit configured to notify the second radio base station of the information which is received by the receiver and indicates a reverse link communication rate required by the application, when handoff of the radio communication terminal from the first radio base station to the second radio base station is performed,
the second radio base station includes:
a storage unit configured to store a plurality of threshold values for changing an upper limit value of a communication rate, for each of the upper limit value set in a stepwise manner;
a receiver configured to receive information indicating a reverse link communication rate required for the application executed by the radio communication terminal, from the first radio base station; and
a notification unit configured to obtain, from the storage unit, the threshold values corresponding to information which is received by the receiver and indicates a reverse link communication rate required for the application, and to notify the radio communication terminal of the selected threshold values when handoff of the radio communication terminal is performed from the first radio base station to the second radio base station,
the radio communication terminal includes:
a transmitter configured to transmit information indicating a reverse link communication rate required for the application to be executed, to the first radio base station;
a receiver configured to receive the threshold values determined based on the notified information indicating a reverse link communication rate, from the second radio base station, when handoff is performed from the first radio base station to the second radio base station; and
a controller configured to control a reverse link communication rate of the application on the basis of the threshold values received by the receiver, after handoff from the first radio base station to the second radio base station is performed.
